(19) United States
(12) Patent Application Publication
(10) Pub. No.: US 2022/0144433 A1
(43) Pub. Date: May 12, 2022

(54) IRRIGATION SYSTEM WITH UNMANNED AERIAL VEHICLES

(71) Applicant: Lindsay Corporation, Omaha, NE (US)

(72) Inventor: Mark William Miller, Elkhorn, NE (US)

(73) Assignee: Lindsay Corporation, Omaha, NE (US)

(21) Appl. No.: 17/522,992

(22) Filed: Nov. 10, 2021

Related U.S. Application Data
(60) Provisional application No. 63/111,712, filed on Nov. 10, 2020.

(51) Int. Cl. B64D 1/18; B64C 39/02; A01G 25/09; A01G 25/16

(52) U.S. Cl. CPC B64D 1/18; B64C 39/024; A01G 25/092; A01G 25/16; B64C 2201/027; B64C 2201/123; B64C 2201/208; B64C 2201/128; B64C 2201/126

(57) ABSTRACT

A mobile irrigation system configured to support an unmanned aerial vehicle (UAV), the mobile irrigation system comprising a number of irrigation spans, a control system, and a UAV support system. Each irrigation span includes a conduit section connected to conduit sections of adjacent irrigation spans for transporting an irrigation fluid from a fluid source to a field, a truss configured to support the conduit section, a number of fluid emitters, and a mobile tower connected to the truss for moving the truss, conduit section, and fluid emitters across the field. The UAV support system includes a docking station configured to receive the UAV and deploy the UAV to collect agricultural data or to carry out agricultural tasks and a data transfer module for transferring agricultural data from the UAV to a remote data storage system or edge processing devices.

### RELATED APPLICATION

The present non-provisional patent application claims priority benefit with regard to all common subject matter, of U.S. Provisional Patent Application No. 63/111,712, filed Nov. 10, 2020, and entitled “IRRIGATION SYSTEM WITH UNMANNED AERIAL VEHICLES” which is hereby incorporated by reference in its entirety into the present application.

### BACKGROUND

Conventional irrigation systems gather minimal data about the field and crops they are irrigating. Unmanned aerial vehicles (UAVs) are often used to collect data, but they require an on-site operator. The operator must rely on external systems to determine when data collection is needed. The irrigation systems, UAVs, and external systems are not integrated, resulting in significant inefficiencies and unfocused data collection. Furthermore, the data is not easily transferred from the UAVs to external computing devices.

### SUMMARY

Embodiments of the present invention solve the above-mentioned problems and other problems and provide a distinct advancement in the art of mobile irrigation systems. More particularly, the invention provides a mobile irrigation system that provides power, docking, mission management and control, data offloading, data management, data analysis, and other support for a UAV.

An embodiment of the invention is a mobile irrigation system broadly comprising a central pivot, a number of spans, a conduit, and a UAV support system configured to accommodate a UAV for gathering agricultural data and performing agricultural tasks.

The UAV is configured to be deployed from the UAV support system automatically or via user input to collect or obtain agricultural data from crops being irrigated by the mobile irrigation system and detect or investigate anomalies related to crop or soil health via aerial or camera imagery. The UAV is also configured to gather data for troubleshooting the mobile irrigation system itself. The UAV may be a multi-rotor, fixed wing, or hybrid drone or other similar unmanned aerial vehicle. The UAV may also include fluid emitters, fluid tanks, hoppers, and other equipment for delivering water, fertilizer, pesticide, and the like to crops in the field.

The central pivot may be a tower or any other support structure about which the spans pivot or rotate. The central pivot has access to a well, water tank, or other source of water and may also be coupled with a tank or other source of agricultural products to inject fertilizers, pesticides and/or other chemicals into the water for application during irrigation.

Each span includes a truss section and a mobile tower. The spans are pivotably connected end-to-end from the central pivot.

Each truss section includes a number of beams rigidly connected to one another to form a framework which carries or otherwise supports the conduit and other fluid distribution mechanisms that are connected in fluid communication to the conduit.

The mobile towers are positioned at outward ends of the spans and each includes wheels and a drive motor. The drive motor may be an electric motor, such as an alternating current (AC) motor or a direct current (DC) motor, and may drive the wheel or wheels directly or through a drive shaft in order to propel the mobile towers forward or backward.

The UAV support system accommodates the UAV and broadly comprises a control system, a user interface, a data transfer module, a power system, and a docking station. The UAV support system may be integral with a control system of the irrigation system or may be an independent or “add-on” system.

The control system comprises processors, controllers, electronic circuits, and the like for executing, processing, or running software, applications, or code. The control system is in electronic communication with other electronic components via wired or wireless communication networks for controlling, programming, communication with, and/or transferring data (including agricultural data) between the mobile irrigation system, UAV, and/or a remote server, cloud service, or other external system, or mobile electronic devices.

The user interface allows a user to at least one of program, activate, and directly control the UAV and to control features, functions, and operation of the mobile irrigation system. The user interface may be retained in a housing located at, or near the center pivot or one of the mobile towers, or may be incorporated in a remote computing device such as a mobile phone, tablet, laptop, or the like.

The data transfer module allows the UAV to communicate with, transfer data (including agricultural data) to, and download software updates, programming, and direct commands from a remote server, cloud service, or other external system, mobile electronic devices, the control system of the mobile irrigation system, the user interface, and the like. The data transfer module may include signal and/or data transmitting and receiving circuits, such as antennas, amplifiers, filters, mixers, oscillators, digital signal processors (DSPs), and the like.

The power system may be an electrical charging system connected to the grid or an independent wind or solar powered unit. The power system automatically charges the UAV when the UAV is docked on the docking station.

The docking station is a landing location that receives, supports, stores, or docks the UAV when the UAV is not deployed and may be positioned on one of the mobile towers or trusses of the mobile irrigation system. Alternatively, the docking station may be positioned near the irrigation system such as near a pump station or control station. The docking station may include electronic connections for communicatively connecting the UAV to the data transfer module and electric connections for connecting the UAV to the power system. The docking station may further include fluid connections for supplying water, fertilizer, chemicals, and the like to the UAV. The docking station may include a locking mechanism for securing the UAV and a housing for protecting the UAV from the elements.

The above-described invention provides several advantages. For example, the UAV support system provides power, docking, mission management and control, data offloading, data management, data analysis, and other UAV support. The UAV support system may deploy the UAV on an automated schedule or on demand to obtain data including agricultural data in a pre-defined or user selected manner. The UAV support system may upload data from the UAV to edge-of-field processing devices (hereinafter “edge processing devices), remote servers, cloud services, and other devices via the mobile irrigation system's infrastructure. The UAV support system may replenish the UAV with water, fertilizer, pesticides, and other chemicals or agricultural material to be sprayed on pests found at specific locations.

### BRIEF DESCRIPTION OF THE DRAWING FIGURES

Embodiments of the current invention are described in detail below with reference to the attached drawing figures, wherein:

FIG. 1 is a perspective view of an irrigation system including a UAV support system and a UAV constructed in accordance with an embodiment of the invention;

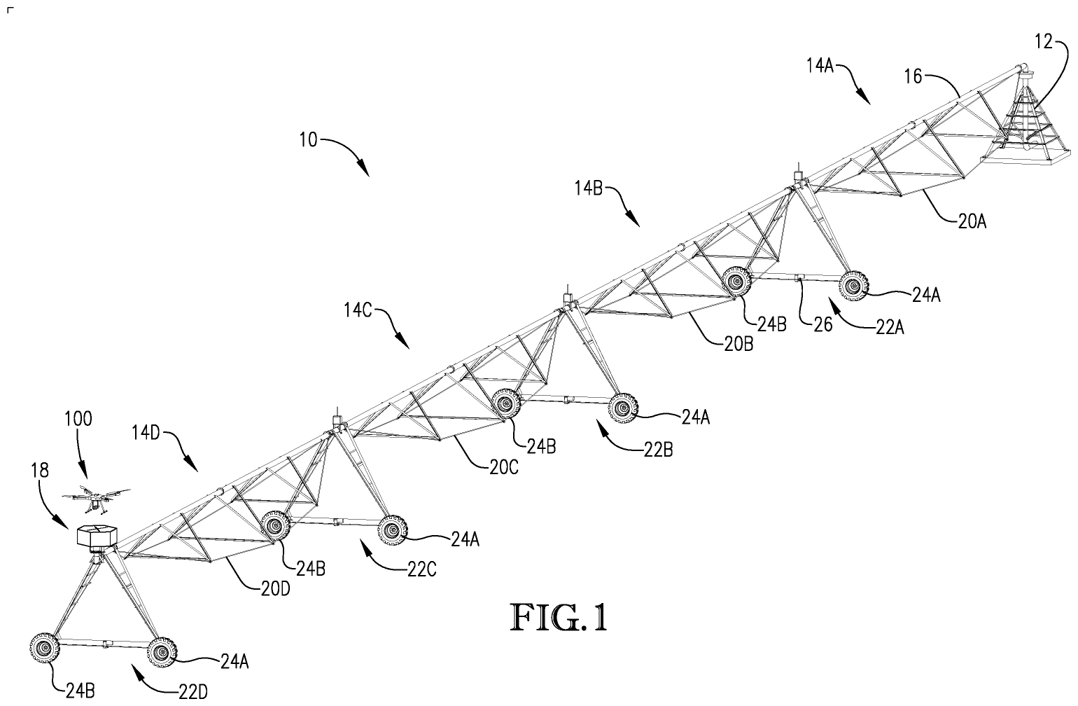

FIG. 2 is a schematic diagram of the UAV support system of FIG. 1;

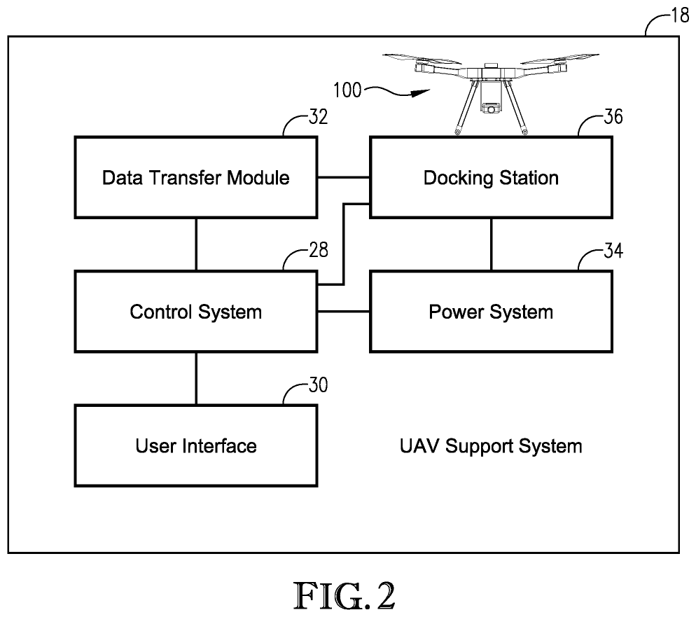

FIG. 3 is a schematic diagram of the UAV of FIG. 1; and

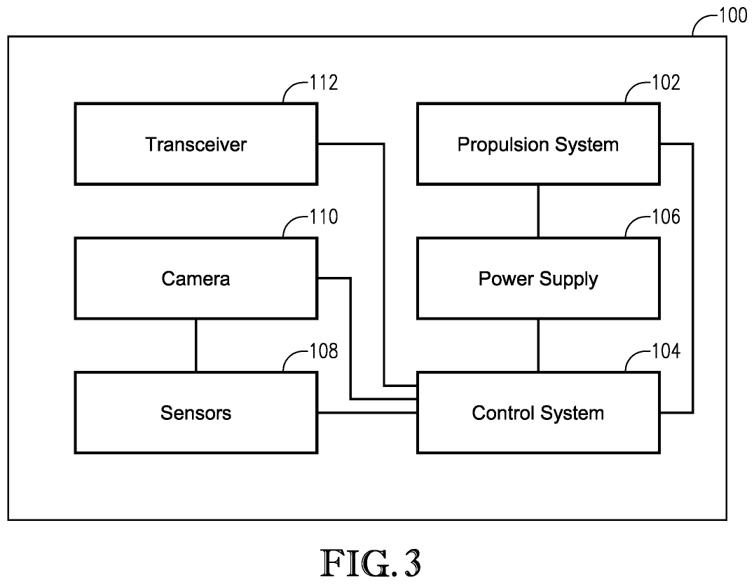

FIG. 4 is a flow diagram showing certain method steps of UAV support.

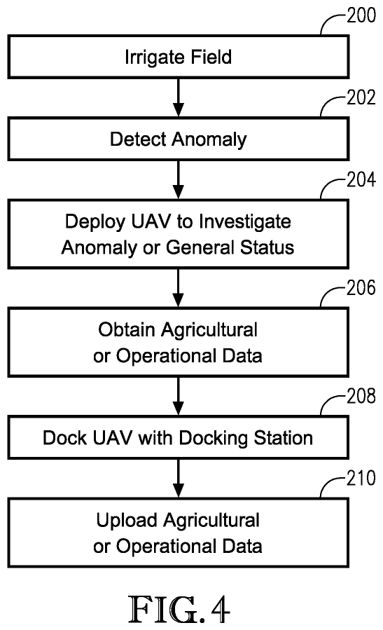

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Turning to the drawing figures, a mobile irrigation system 10 constructed in accordance with various embodiments of the invention is illustrated. The mobile irrigation system 10 broadly comprises a fixed central pivot 12, a plurality of spans 14A-D, a conduit 16, and an unmanned aerial vehicle UAV support system 18 configured to accommodate at least one unmanned aerial vehicle (UAV) 100 for gathering agricultural data and performing agricultural tasks. The mobile irrigation system 10 may also comprise an extension arm (also commonly referred to as a “swing arm” or “corner arm”) pivotally connected to the free end of the outermost span 14C. The mobile irrigation system 10 may also be embodied by a lateral (i.e. linear) move apparatus, hose reel apparatus, and other irrigation systems without departing from the scope of the current invention.

The UAV 100 may include a propulsion system 102, a control system 104, a power supply 106, sensors 108, a camera 110, a transceiver 112, and other electronic equipment for collecting agricultural data. The UAV 100 may further include fluid emitters, fluid tanks, hoppers, and other equipment for delivering water, fertilizer, pesticide, and the like to crops in the field. The UAV 100 may be a multi-rotor, fixed wing, or hybrid drone or other similar unmanned aerial vehicle.

The propulsion system 102 may include rotors, propellers, airfoils, motors, engines, or the like. In one embodiment, the UAV 100 is a quadcopter including four vertical-thrust rotors.

The control system 104 dictates movement and actions of the UAV 100 and may include a processor, a controller, a memory, and/or other computing elements. The control system 104 may implement aspects of the present invention with one or more computer programs stored in or on computer-readable medium residing on or accessible by the processor. Each computer program preferably comprises an ordered listing of executable instructions for implementing logical functions in the processor. Each computer program can be embodied in any non-transitory computer-readable medium, such as the memory, for use by or in connection with an instruction execution system, apparatus, or device, such as a computer-based system, processor-containing system, or other system that can fetch the instructions from the instruction execution system, apparatus, or device, and execute the instructions. The control system 104 may also include a GPS unit or equivalent for receiving and interpreting positional data from a satellite array.

The power supply 106 may be a rechargeable battery or a tethered power cable. The rechargeable battery should carry a charge long enough to complete one or several missions and may be recharged at the docking station of the UAV support system of the mobile irrigation system 10 (described in more detail below). A tethered power cable may allow infinite flight time but limited flight range.

The sensors 108 may include motion sensors, proximity sensors, temperature sensors, humidity sensors, and the like. The sensors 108 may be used for gathering mission data and for maneuvering and navigation of the UAV 100. For example, one of the sensors 108 may be used to detect proximity to an obstacle, and another one of the sensors 108 may be used to gather humidity data for determining crop health.

The camera 110 may be mounted to a frame of the UAV 100 via a gimbal. The camera 110 may include image and video capturing capabilities and may be used for gathering mission data and for maneuvering and navigating the UAV 100.

The transceiver 112 may be a transmitter/receiver for transmitting and receiving data between the UAV 100 and external computing devices. The transceiver 112 may be configured to transmit and receive data over a wireless communication network or via RF broadcast signals.

The central pivot 12 may be a tower or any other support structure about which the spans 14A-D pivot or rotate. The central pivot 12 has access to a well, water tank, or other source of water and may also be coupled with a tank or other source of agricultural products to inject fertilizers, pesticides and/or other chemicals into the water for application during irrigation. The central pivot 12 may supply water to a conduit 16 or pipe which carries the water along the length of the spans 14A-D.

Each span 14A-D includes a truss section 20A-D and a mobile tower 22A-D. The spans 14A-D are pivotably connected end-to-end from the central pivot 12.

Each truss section 20A-D includes a plurality of beams rigidly connected to one another to form a framework which carries or otherwise supports the conduit 16 and other fluid distribution mechanisms that are connected in fluid communication to the conduit 16. Fluid distribution mechanisms may include sprayers, diffusers, or diffusers, each optionally attached to a drop hose, or the like. In addition, the conduit 16 may include one or more valves which control the flow of water through the conduit 16. The opening and closing of the valves may be automatically controlled with an electronic signal or digital data.

The mobile towers 22A-D are positioned at outward ends of the spans 14A-D and each includes at least two wheels 24A,B, at least one of which is driven by a drive motor 26. The drive motor 26 may be an electric motor, such as an alternating current (AC) motor or a direct current (DC) motor, and may drive the wheel or wheels 22A,B directly or through a drive shaft in order to propel the mobile towers 22A-D forward or backward. Each mobile tower 22A-D further includes a plurality of beams rigidly connected to one another to form a framework which couples the conduit 16 and the truss sections 20A-D to the wheels 24A,B and the drive motor 26.

The UAV support system 18 accommodates the UAV 100 and broadly comprises a control system 28, a user interface 30, a data transfer module 32, a power system 34, and a docking station 36. The UAV support system 18 may be integral with a control system of the irrigation system or may be an independent or “add-on” system. Although only one UAV support system 18 is shown, several UAV support systems may be integrated on the mobile irrigation system 10.

The control system 28 may comprise one or more processors, microprocessors (single-core or multi-core), microcontrollers, digital signal processors (DSPs), field-programmable gate arrays (FPGAs), analog and/or digital application-specific integrated circuits (ASICs), or the like, or combinations thereof. The control system 28 may generally execute, process, or run instructions, code, code segments, code statements, software, firmware, programs, applications, apps, processes, services, daemons, or the like. The control system 28 may also include hardware components such as registers, finite-state machines, sequential and combinational logic, configurable logic blocks, and other electronic circuits that can perform the functions necessary for the operation of the current invention. In certain embodiments, the control system 28 may include multiple computational components and functional blocks that are packaged separately but function as a single unit. The control system 28 may be in electronic communication with other electronic components through serial or parallel links that include universal busses, address busses, data busses, control lines, and the like.

The control system 28 may include, perhaps as an embedded device or an integrated device, or be in electronic communication with, a memory element. The memory element may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element may be embedded in, or packaged in the same package as, the control system 28. The memory element may include, or may constitute, a non-transitory “computer-readable medium”. The memory element may store the instructions, code, code statements, code segments, software, firmware, programs, applications, apps, services, daemons, or the like that are executed by the control system 28. The memory element may also store data that is received by the control system 28 or the device in which the control system 28 is implemented. The control system 28 may further store data or intermediate results generated during processing, calculations, and/or computations as well as data or final results after processing, calculations, and/or computations. In addition, the memory element may store settings, data, documents, sound files, photographs, videos, images, databases, and the like.

The user interface 30 generally allows a user to at least one of program, activate, and directly control the UAV and to control features, functions, and operation of the mobile irrigation system 10. The user interface 30 may be retained in a housing located at, or near the center pivot or one of the mobile towers, or may be incorporated in a remote computing device such as a mobile phone, tablet, laptop, or the like. Inputs may include a touchscreen, buttons, pushbuttons, knobs, jog dials, shuttle dials, directional pads, multidirectional buttons, switches, keypads, keyboards, mice, joysticks, microphones, or the like, or combinations thereof. Additionally, or alternatively, the user interface 30 may include a software interface that is implemented in a mobile electronic device application, a desktop or laptop computer application, a website application, or the like.

The data transfer module 32 generally allows the UAV 100 to communicate with, transfer data (including agricultural data) to, and download software updates, programming, and direct commands from a remote server, cloud service, or other external system, mobile electronic devices, the control system 28 of the mobile irrigation system 10, the user interface 30, and the like. The data transfer module 32 may include signal and/or data transmitting and receiving circuits, such as antennas, amplifiers, filters, mixers, oscillators, digital signal processors (DSPs), and the like. The data transfer module 32 may establish communication wirelessly by utilizing radio frequency (RF) signals and/or data that comply with communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof. In addition, the data transfer module 32 may utilize communication standards such as ANT, ANT+, Bluetooth™ low energy (BLE), the industrial, scientific, and medical (ISM) band at 2.4 gigahertz (GHz), or the like.

The power system 34 may be an electrical charging system connected to the grid or an independent wind or solar powered unit. The power system 34 automatically charges the UAV 100 when the UAV 100 is docked on the docking station 36.

The docking station 36 is a landing location that receives, supports, stores, or docks the UAV 100 when the UAV 100 is not deployed and may be positioned on one of the mobile towers or trusses of the mobile irrigation system 10. Alternatively the docking station 10 may be positioned near the irrigation system such as near a pump station or control station. The docking station 36 may include electronic connections for communicatively connecting the UAV 100 to the data transfer module 32 and electric connections for connecting the UAV 100 to the power system 34. The docking station 36 may further include fluid connections for supplying water, fertilizer, chemicals, and the like to the UAV 100. The docking station 36 may include a locking mechanism for securing the UAV 100 and a housing for protecting the UAV 100 from the elements.

In use, the mobile irrigation system 10 may irrigate or apply fertilizer or chemicals to the field according to an irrigation, fertilization, or chemical dispersion plan or according to direct user input, as shown in block 200. Sensors onboard the mobile irrigation system 10 or positioned in the field, farmer observation, or external systems or models may detect or identify an anomaly or crop status, as shown in block 202. The UAV support system 18 may launch the UAV 100 to detect or investigate the anomaly via aerial or camera imagery collected by the camera 110 and sensors 108, as shown in block 204. For example, the UAV 100 may be launched to obtain agricultural data (e.g., vegetation indices such as NDVI and EVI) pertaining to crop health anomalies which may be triggered by pests, diseases, nutrient deficiencies, and abnormally low or high moisture levels, as shown in block 206. Other agricultural data can be obtained to verify crop growth stage changes and to analyze larger areas if source data is limited. The UAV support system 18 may further launch the UAV 100 to investigate general soil moisture levels and irrigation system operational issues such as flat tires, alignment problems, and sprinkler package issues including plugged sprinklers, fluid application discrepancies, overwatering, and underwatering.

The UAV support system 18 may then dock the UAV 100 when the agricultural or operational data has been obtained, as shown in block 208. The UAV 100 may mate to electronic and electrical connections for data upload for recharging the UAV's battery. The UAV 100 may also dock to recharge its battery if low battery is detected during flight. The UAV 100 may automatically resume flight after ample battery charge is detected. The UAV 100 may also dock if camera or sensor failure or malfunction is detected. The failed or malfunctioning component or system may be analyzed or repaired after the UAV 100 has docked.

Agricultural and operational data may then be uploaded to at least one of the data transfer module 32, edge processing devices, cloud services, and remote servers for processing, as shown in block 210. In another embodiment, data and images may be live-streamed from the UAV 100 to at least one of the data transfer module 32, edge processing devices, cloud services, and remote servers for processing and real-time analytics. The data and images may be stored locally at the data transfer module 32 or on the UAV 100 if a cloud connection or wireless connection is lost. Similarly, the data and images may be stored on another device via auto-switch routing if the intended storage device is unavailable, is under heavy load (i.e., load balancing), or does not exist. This may require a local connection (e.g., via a WiFi network) to the alternate storage device.

In another embodiment, the UAV support system 18 may launch the UAV 100 to detect or investigate anomalies from other sources. For example, the UAV support system 18 may launch the UAV 100 to investigate weather changes. Specifically, the UAV 100 may be deployed after a weather event to analyze potential damage to crops and re-assess crop health. The UAV support system 18 may dock the UAV 100 if bad weather such as high winds, rain, or hail is approaching. The UAV support system 18 may also house or shelter the UAV 100 when the UAV 100 is docked to protect the UAV 100.

The UAV support system 18 may also launch the UAV 100 to verify soil moisture levels determined according to other sources such as field sensors and computer models. Specifically, the UAV support system 18 may launch the UAV 100 to analyze and verify crop health and soil moisture levels in particular areas of interest. In one embodiment, the UAV support system 18 may dock the UAV 12 after all areas of interest have been analyzed.

In another embodiment, the UAV support system 18 may deploy the UAV 100 to aid with irrigation system navigation. For example, the UAV 12 may identify the irrigation system's proximity to obstacles, areas, and items of interest. This may help the mobile irrigation system 10 navigate around creeks, ponds, buildings, structures, roads, barriers, temporary obstacles, and movable obstacles. In one embodiment, the UAV support system 18 may deploy the UAV 100 when the mobile irrigation system 10 is in proximity with one of these items and then dock the UAV 100 after the mobile irrigation system 10 is no longer in proximity.

In another embodiment, a user may activate or initiate flight of the UAV 100 via the user interface 30 or a remote application. For example, the user may define a flight path and then select “start” or may schedule flights to commence at set times. The user may program the UAV 100 to fly a particular flight path and perform a set of tasks. The user may also select from pre-defined flight paths and checkpoints or create new flight paths and checkpoints for collecting data. Similarly, the user may select from pre-defined tasks or create new tasks to be completed. The UAV 100 may then dock once the flight and tasks are complete.

An exemplary task to be completed by the UAV 100 will now be described. Once pests such as weeds, insects, fungi, or the like are found in the field, the UAV 100 may be loaded with anti-pest chemicals and instructed to administer the anti-pest chemicals to precise, predefined locations that the pests have been found. Specifically, the appropriate chemical for the pest may be automatically loaded from the docking station 36 on the mobile irrigation system 10 into the UAV 100 for spraying on the pre-defined locations in the field. As such, the docking station 36 may be able to automatically load and administer multiple types of pest chemicals. This allows pest control to be managed remotely (i.e., without farmer coming on-site).

The above-described invention provides several advantages. For example, the UAV support system provides power, docking, mission management and control, data offloading, data management, data analysis, and other UAV support. The UAV support system may deploy the UAV on an automated schedule or on demand to obtain data including agricultural data in a pre-defined or user selected manner. The UAV support system may upload data from the UAV to edge processing devices, remote servers, cloud services, and other devices via the irrigation system's infrastructure. The UAV support system may replenish the UAV with water, fertilizer, pesticides, and other chemicals or agricultural material to be sprayed on pests found at specific locations. This allows precise remote control of chemicals on exact locations that pests have been found instead of broadcast spraying that wastes chemicals and may needlessly harm crops. This also allows agricultural tasks to be carried out without a farmer coming onsite.

The mobile irrigation system and UAV support system eliminate the need for a farmer to pay for a service to collect agricultural data. The mobile irrigation system 10 and UAV support system eliminate the unavailability of such data that is dictated by the service's schedule and available resources. Furthermore, the mobile irrigation system and UAV support system can collect and analyze only data that is needed and can perform tasks according to findings of the data analysis.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Patent claims stemming from this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in any claims stemming from this application.

Having thus described various embodiments of the technology, patentable subject matter may include the following:

1. A mobile irrigation system configured to support an unmanned aerial vehicle (UAV), the mobile irrigation system comprising:
a plurality of irrigation spans, each including:
a conduit section connected to conduit sections of adjacent irrigation spans for transporting an irrigation fluid from a fluid source to a field;
a truss configured to support the conduit section;
a plurality of fluid emitters connected to the conduit section for delivering the irrigation fluid to crops in the field; and
a mobile tower connected to the truss and configured to move the truss, conduit section, and fluid emitters across the field, the mobile tower including:
a wheel assembly for traversing the field; and
a drive train having a motor for powering the wheel assembly;
a control system for controlling the motors of the mobile towers; and
a UAV support system including a docking station configured to receive the UAV and to deploy the UAV to collect agricultural data.

2. The mobile irrigation system of claim 1, the UAV support system further including a data transfer module for transferring agricultural data from the UAV to a remote data storage system.

3. The mobile irrigation system of claim 2, the UAV support system further including a power system for powering the data transfer module and recharging the UAV when the UAV is docked at the docking station.

4. The mobile irrigation system of claim 1, wherein the UAV support system is configured to automatically deploy the UAV.

5. The mobile irrigation system of claim 1, wherein the UAV support system is configured to deploy the UAV upon receiving a user flight initiation input.

6. The mobile irrigation system of claim 1, wherein the UAV support system is configured to live-stream agricultural data received from the UAV to the remote data storage system, a computing cloud, or edge computing devices.

7. The mobile irrigation system of claim 1, wherein the UAV support system further includes a memory configured to store the agricultural data.

8. The mobile irrigation system of claim 1, wherein the UAV support system is configured to replenish the UAV with agricultural material for performing agricultural tasks.

9. A mobile irrigation system comprising:
a plurality of irrigation spans, each including:
a conduit section connected to conduit sections of adjacent irrigation spans for transporting an irrigation fluid from a fluid source to a field;
a truss configured to support the conduit section;
a plurality of fluid emitters connected to the conduit section for delivering the irrigation fluid to crops in the field; and
a mobile tower connected to the truss and configured to move the truss, conduit section, and fluid emitters across the field, the mobile tower including:
a wheel assembly for traversing the field; and
a drive train having a motor for powering the wheel assembly;
a control system for controlling the motors of the mobile towers;
an unmanned aerial vehicle configured to be deployed for collecting agricultural data, the UAV including:
a propulsion system for maneuvering the UAV in the air;
a control system for directing the UAV to collect the agricultural data and carry out agricultural tasks; and
a power source for powering the propulsion system and the control system of the UAV; and
a UAV support system including:
a docking station configured to receive the UAV and deploy the UAV to collect agricultural data;
a data transfer module for transferring agricultural data from the UAV to a remote data storage system; and
a power system for powering the data transfer module and recharging the UAV when the UAV is docked at the docking station.

10. The mobile irrigation system of paragraph 9, wherein the UAV is configured to be deployed to investigate agricultural anomalies.

11. The mobile irrigation system of paragraph 9, wherein the UAV is configured to be deployed to investigate agricultural anomalies detected from other sources.

12. The mobile irrigation system of paragraph 9, wherein the UAV is configured to be deployed to monitor ground vehicles, other UAVs, humans, or animals in an area patrolled by the UAV.

13. The mobile irrigation system of paragraph 9, wherein the UAV is configured to be deployed to assist in irrigation system navigation.

14. The mobile irrigation system of paragraph 9, wherein the UAV is configured to be deployed to accomplish a user-initiated flight.

15. The mobile irrigation system of paragraph 9, wherein the UAV is configured to be deployed to fly under direct user control.

16. The mobile irrigation system of paragraph 9, wherein the UAV is configured to live-stream agricultural data to the remote data storage system, a computing cloud, or edge computing devices via the data transfer module.

17. The mobile irrigation system of paragraph 16, wherein the UAV is configured to store the agricultural data on the data transfer module or on an edge computing device if the computing cloud is inaccessible to the data transfer module or is under heavy load.

18. The mobile irrigation system of claim 9, wherein the UAV is configured to perform agricultural tasks.

19. The mobile irrigation system of claim 18, wherein the UAV support system is configured to replenish the UAV with agricultural material.

20. A mobile irrigation system configured to support an unmanned aerial vehicle (UAV), the mobile irrigation system comprising:
a plurality of irrigation spans, each including:
a conduit section connected to conduit sections of adjacent irrigation spans for transporting an irrigation fluid from a fluid source to a field;
a truss configured to support the conduit section;
a plurality of fluid emitters connected to the conduit section for delivering the irrigation fluid to crops in the field; and
a mobile tower connected to the truss and configured to move the truss, conduit section, and fluid emitters across the field, the mobile tower including:
a wheel assembly for traversing the field; and
a drive train having a motor for powering the wheel assembly;
a control system for controlling the motors of the mobile towers; and
a UAV support system including:
a docking station configured to receive the UAV when the UAV is not deployed;
a data transfer module configured to live-stream agricultural data received from the UAV to a remote data storage system, a computing cloud, or edge computing devices; and
a power system for powering the data transfer module and recharging the UAV when the UAV is docked at the docking station,
the UAV support system being configured to automatically deploy the UAV to collect agricultural data according to an automated schedule and on demand upon receiving a user flight initiation input and to replenish the UAV with agricultural material for performing agricultural tasks.
